(19) United States
(12) Patent Application Publication
(10) Pub. No.: US 2013/0058790 A1
(43) Pub. Date: Mar. 7, 2013

(54) CENTRIFUGAL IMPELLERS STRUCTURE

(71) Applicant: CHUN-CHIEH CHEN, Taichung City (TW)

(72) Inventor: CHUN-CHIEH CHEN, Taichung City (TW)

(21) Appl. No.: 13/555,199

(22) Filed: Jul. 23, 2012

(30) Foreign Application Priority Data
Sep. 1, 2011 (CN) 201120325930.6

(51) Int. Cl. F03B 3/12

(52) U.S. Cl. 416/186 R

(57) ABSTRACT

A centrifugal impellers structure is mounted to a transportation vehicle that has a wheel and a wheel hub and includes first and second centrifugal impellers. The first centrifugal impeller is in operative coupling with a free wheel hub axle mounted to the wheel hub and includes a top plate and a bottom plate, between which blades are mounted. The plates each form at least one inlet. The blades are arranged not to shield and block the inlets and define therebetween channels communicating with the inlets. The second centrifugal impeller is coupled to a rim of the wheel and includes a top plate and a bottom plate, between which blades are mounted. When the first and second centrifugal impellers are caused to rotate, the first centrifugal impeller generates an aerodynamic force that drives the second centrifugal impeller and the second centrifugal impeller generates a rotary force to drive the wheel.

### (a) TECHNICAL FIELD OF THE INVENTION

The present invention generally relates to centrifugal impellers structure, and more particularly to a centrifugal impellers structure that is particularly applicable to a transportation vehicle comprising wheels and hubs to be driven by aerodynamic force to rotate and to use the rotary force to drive the wheels to rotate so as to increase the moving speed of the transportation vehicle and that is easy to manufacture and assemble and can provide an improved air intake performance for aerodynamic force.

### (b) DESCRIPTION OF THE PRIOR ART

The progress of technology and science brings fast development of transportation vehicles. Simplification, humanization, and lightweight are the extreme goals that the industry is seeking for. Through the use of composite material, the weight of vehicle is effectively reduced. Through introduction of ergonomic designs, the use of vehicle is made reasonable and the complexity of design is reduced. All these goals are of no easy accomplishment and must always be considered together with the factors of cost and performance.

A conventional speed change mechanism relies on a complicated speed reduction mechanism to vary torque. However, such a complicated speed reduction mechanism increases the overall weight of a transportation vehicle and makes the calibration process of assembling and operation of gear shifting inconvenient.

Taiwan Utility Model No. M398514, issued to the present inventor, discloses a speed change device, which converts aerodynamic power into torque, wherein a primary mechanism is composed of a driving centrifugal impeller and a driven centrifugal impeller of which the mechanism is easy to assemble and convert aerodynamic power into torque to increase the moving speed of a transportation vehicle, whereby improved acceleration performance that is far better than the conventional speed change devices can be achieved and requiring no gear-shifting operations, making it easy to operate by the users.

The present invention is provided to make the manufacturing and assembling of a speed change device easy and the air intake performance for aerodynamic power improved thereby realizing better acceleration performance.

### SUMMARY OF THE INVENTION

An object of the present invention is to provide a centrifugal impellers structure that is driven by aerodynamic power to rotate and uses the rotary force to drive wheels of a transportation vehicle to rotate for increasing the moving speed of the transportation vehicle.

Another object of the present invention is to provide a centrifugal impellers structure that is easy to manufacture and assemble.

A further object of the present invention is to provide a centrifugal impellers structure that provides improved air intake performance for aerodynamics thereby improving acceleration performance.

To achieve the above objects, the present invention is mounted to a transportation vehicle that has a wheel and a wheel hub and structurally comprises a first centrifugal impeller and a second centrifugal impeller. The first centrifugal impeller comprises a top plate and a bottom plate, between which a plurality of blades is mounted. The plates each form at least one inlet. The blades are arranged not to shield and block the inlets. The blades define therebetween channels that are in communication with the inlets. The first centrifugal impeller is in operative coupling with a free wheel hub axle mounted to the wheel hub. The second centrifugal impeller comprises a top plate and a bottom plate, between which a plurality of blades is mounted. One of the plates is coupled to a rim of the wheel. When the free wheel hub axle is rotated, the first centrifugal impeller and the second centrifugal impeller are caused to rotate so that the first centrifugal impeller generates an aerodynamic force that drives the second centrifugal impeller and the second centrifugal impeller generates a rotary force to drive the wheel to thereby increase the moving speed of the transportation vehicle, to make the manufacture and assembling easy, and to improve air intake performance of the inlets.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view, partly exploded, showing the present invention.

FIG. 2 is an exploded view of the present invention.

FIG. 3 is a side elevational view showing operation of the present invention.

FIG. 3A is a partial enlarged view of FIG. 3.

FIG. 4 is a schematic view illustrating the present invention employing aerodynamic power to increase moving speed of a bicycle.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

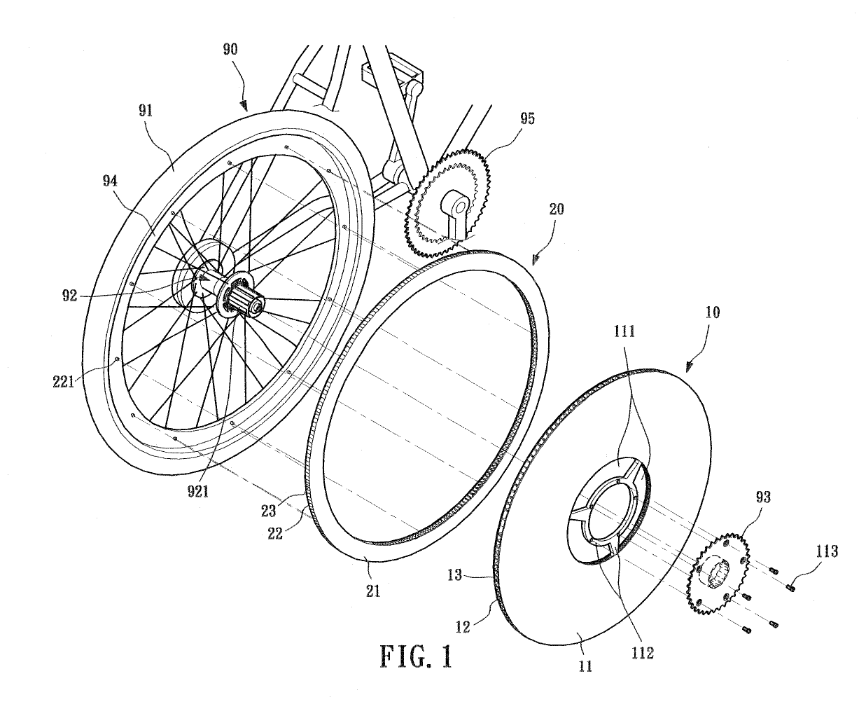

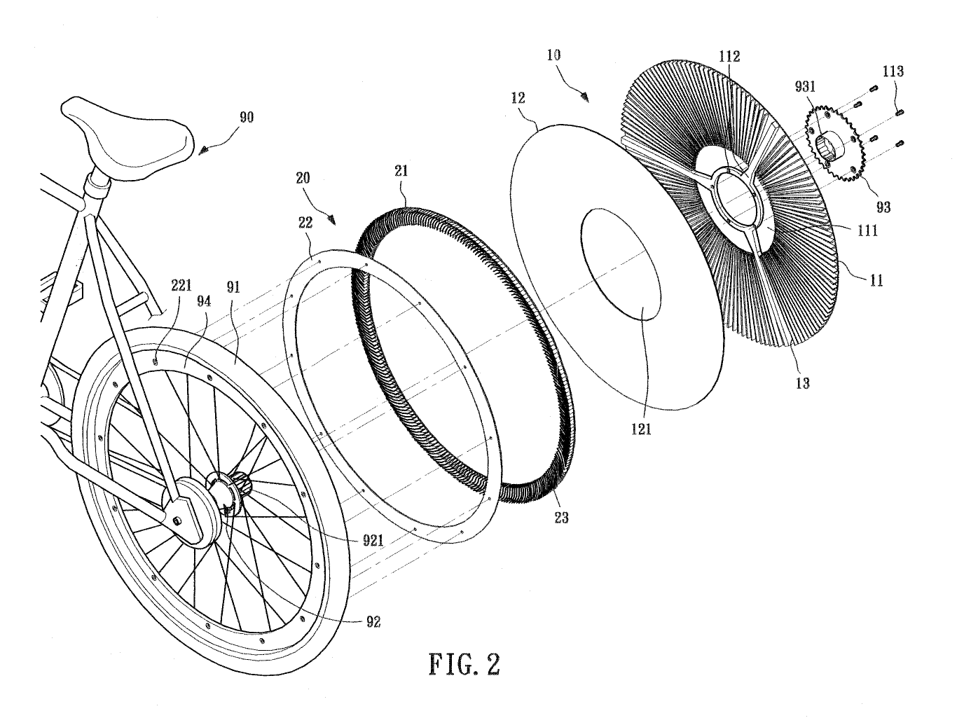

Referring to FIGS. 1, 2, and 4, a structure according to a preferred embodiment of the present invention is applicable to a transportation vehicle, such as a rear wheel 91 of a bicycle 90 a first centrifugal impeller 10 and a second centrifugal impeller 20, whereby the first centrifugal impeller 10 generates aerodynamic power that is used to drive the second centrifugal impeller 20 and rotary force of the second centrifugal impeller 20 is used to drive the rear wheel 91, so as to increase the moving speed of the bicycle 90.

Referring to FIGS. 1, 2, and 3, according to the present invention, the first centrifugal impeller 10 comprises a top plate 11 and a bottom plate 12 between which a plurality of blades 13 that define a plurality of channels is mounted. The top plate 11 and the blades 13 are first integrally formed together and then the bottom plate 12 is mounted to the blades 13. One of the plates, such as the bottom plate 12, forms an inlet 121, while the other one of the top plates, such as the top plate 11, forms a plurality of inlets 111. The blades 13 are arranged not to shield or block the inlets 111, 121 and further the channels defined between the blades 13 are in communication with the inlets 111, 121. As such, when the first centrifugal impeller 10 rotates, external air that is drawn through the inlets 111, 121 are directly and efficiently introduced into the channels defined between the blades 13 thereby improving the air intake performance of the inlets 111, 121. A combined part 112 is formed among the inlets 111. In this way, the components of the first centrifugal impeller 10 have simple structures and are easy to manufacture.

The second centrifugal impeller 20 comprises a top plate 21 and a bottom plate 22 between which a plurality of blades 23 that defines a plurality of channels is mounted. The top plate 21 is integrally formed with the blades 23 and then the bottom plate 22 is mounted to the blades 23. In this way, the components of the second centrifugal impeller 20 have simple structures and are easy to manufacture.

When the first centrifugal impeller 10 and the second centrifugal impeller 20 of the present invention are mounted to a bicycle 90, the combined part 112 of the first centrifugal impeller 10 can be mounted to a free wheel 93 of the bicycle 90 (such as the rear first sprocket of the bicycle that has the greatest number of teeth and is often referred to as the first gear) by a plurality of connecting parts 113, such as screws, so as to couple the first centrifugal impeller 10 to the free wheel 93. The rear wheel 91 of the bicycle 90 has a wheel hub 92 that comprises a free wheel hub axle 921. The free wheel 93 is coupled to the free wheel hub axle 921 by means of a free wheel sleeve 931, so that the free wheel 93, the first centrifugal impeller 10, the free wheel hub axle 921, and the wheel hub 92 are in operative coupling with each other. The bottom plate 22 of the second centrifugal impeller 20 is mounted to a rim 94 of the rear wheel 91 by a plurality of combined parts 221, such as bolts. As such, the present invention has components and structure that are simple and can be easily mounted to a bicycle 90.

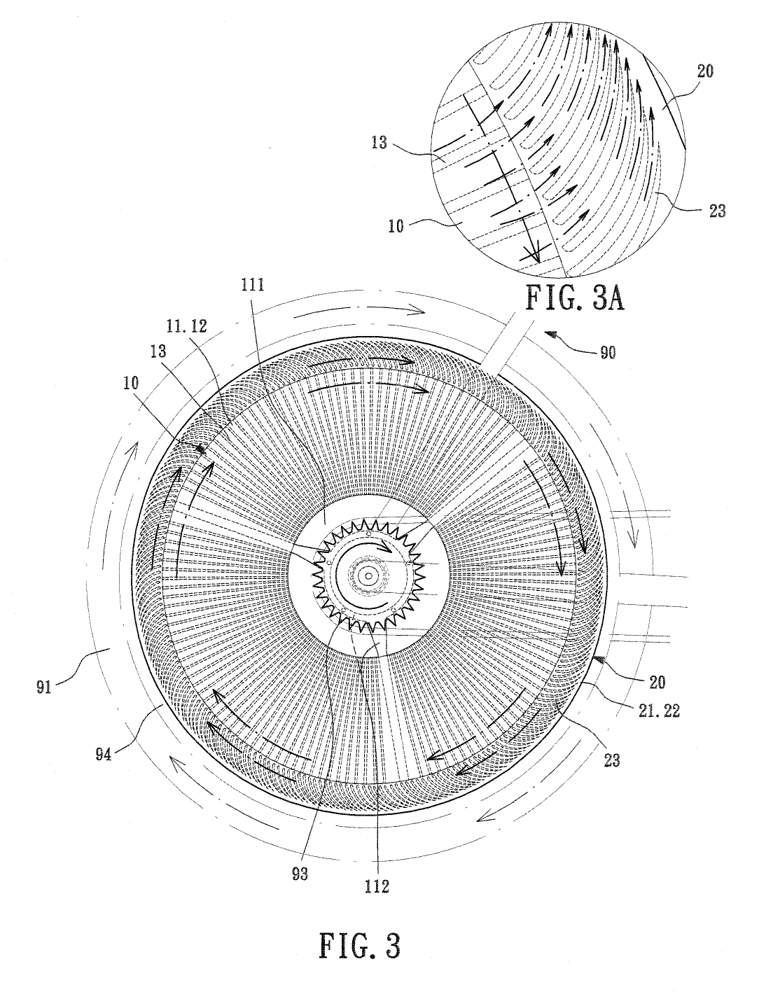

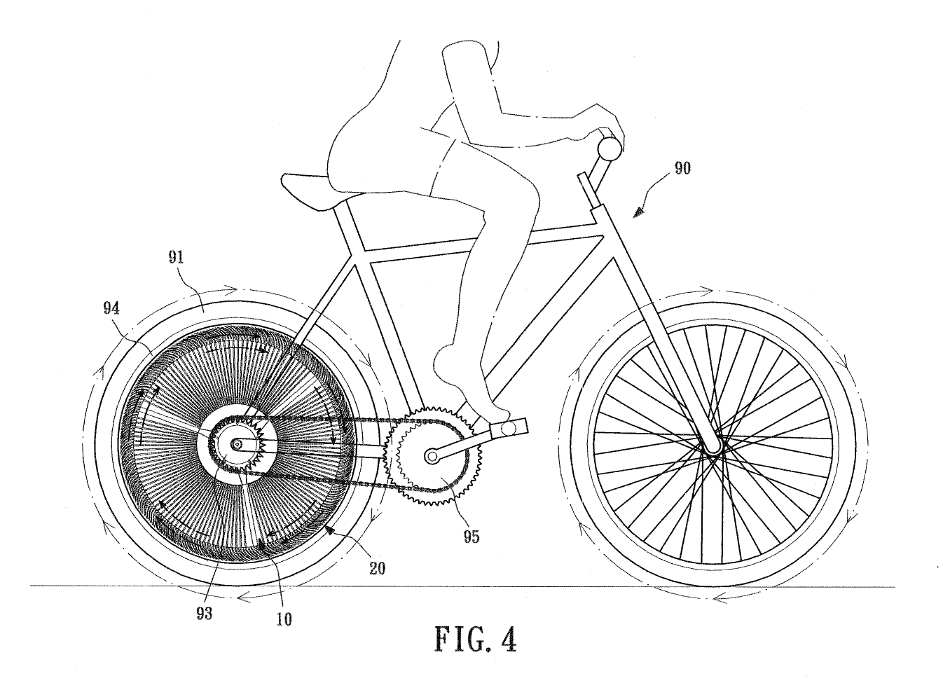

Referring to FIGS. 3 and 4, when the free wheel 93 of the bicycle 90 is driven by a chain wheel 95 of the bicycle 90 to rotate, the first centrifugal impeller 10 and the second centrifugal impeller 20 are caused to rotate. The first centrifugal impeller 10 generates aerodynamic force that drives the second centrifugal impeller 20, and the second centrifugal impeller 20 generates a rotary force that drives the rear wheel 91, so as to increase the moving speed of the bicycle 90.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A centrifugal impellers structure, which is adapted to mount to a transportation vehicle that has a wheel and a wheel hub, the structure comprising:
a first centrifugal impeller, which comprises a top plate and a bottom plate, between which a plurality of blades is mounted, the plates each forming at least one inlet, the blades being arranged not to shield and block the inlets, the blades defining there between channels that are in communication with the inlets, the first centrifugal impeller being in operative coupling with a free wheel hub axle mounted to the wheel hub; and
a second centrifugal impeller, which comprises a top plate and a bottom plate, between which a plurality of blades is mounted, one of the plates being coupled to a rim of the wheel;
whereby when the free wheel hub axle is rotated, the first centrifugal impeller and the second centrifugal impeller are caused to rotate and the first centrifugal impeller generates an aerodynamic force that drives the second centrifugal impeller and the second centrifugal impeller generates a rotary force to drive the wheel.

2. The centrifugal impellers structure according to claim 1, wherein the first centrifugal impeller comprises a combined part and is coupled by the combined part to a free wheel mounted to the free wheel hub axle.

3. The centrifugal impellers structure according to claim 1, wherein one of the plates of the second centrifugal impeller is coupled to the rim of the wheel by a plurality of combined parts.
